(19) United States
(12) Patent Application Publication
(10) Pub. No.: US 2012/0029942 A1
(43) Pub. Date: Feb. 2, 2012

(54) User-Specific Data Provision System, User-Specific Data Provision Method, Server Device, and Handheld Device

(75) Inventors: Koji Katsuki, Kyoto-shi (JP); Go Shionoya, Kyoto-shi (JP); Kazuya Iketani, Kyoto-shi (JP)

(73) Assignee: ARKRAY, Inc., Kyoto (JP)

(21) Appl. No.: 13/259,907

(22) PCT Filed: Apr. 9, 2010
(86) PCT No.: PCT/JP2010/056465

§ 371 Date: Oct. 13, 2011

(30) Foreign Application Priority Data
Apr. 17, 2009 (JP) 2009-101291
Oct. 27, 2009 (JP) 2009-246936

(51) Int. Cl. G06Q 50/24

(52) U.S. Cl. 705/3

(57) ABSTRACT

A user-specific data provision system includes: a handheld device transmitting user-specific information held specifically by a user and user's biometric information acquired by measuring biometric information of the user; the server device receiving the user-specific information and the user's biometric information; and a medical facility terminal receiving information transmitted from the server device, a server device including an access point information determining unit acquiring access point information representing an access point to which the handheld device belongs at present and determining whether the access point is changed or not, at least one of the handheld device and the server device, further including a biometric information prediction determining unit determining whether or not the user's biometric information satisfies a predetermined criterion, wherein the server device transmits the user-specific information to the medical facility terminal when determining that the access point is changed and/or when determining that the predetermined criterion is satisfied.

### TECHNICAL FIELD

The present invention relates to a user-specific data (information) provision system for providing information held specifically by a user himself or herself, a user-specific data (information) provision method, a server device, a medical facility terminal and a handheld device.

### BACKGROUND ART

There is proposed a conventional system receiving blood glucose level information transmitted from a handheld type blood glucose level measuring device via an access point and managing the received blood glucose level information by a server. The system providing proper medical information to a user when abnormality in a state of the blood glucose occurs (refer to, e.g., Patent document 1). Further, it is proposed that a technology for continuously monitoring a concentration of the in-vivo blood glucose level of a human being and an animal, calculating the blood glucose level concentration which changes with time by a predetermined function expression and predicting a prospective blood glucose level concentration (refer to, e.g., Patent document 2).

### DOCUMENTS OF PRIOR ARTS

### Patent Documents

Patent document 1: Japanese Patent Application Laid-Open Publication No. 2003-057244
Patent document 2: Japanese Patent Application Laid-Open Publication No. 2005-308742

### SUMMARY OF THE INVENTION

### Problems to be Solved by the Invention

However, when a user falls into a state of unconsciousness such as a comatose state due to hypoglycaemia and is carried to a medical facility, a medical worker is not able to acquire information that is specifically held by the user himself or herself (which will hereinafter be referred to as user-specific information) from the user, and it is therefore difficult to implement a proper medical care, a proper diagnosis and a proper dosage of medicine matching with the user. The user-specific information is exemplified by, e.g., contents and amounts of the meals in recent one week (e.g., an amount of ingested carbohydrate), hours of sleep, hours of exercise, a daily-ingested medicine, an ingestion frequency thereof, anamnesis, a medical history, a chronic disease, allergy, etc. Especially when the user moves to a remote place or when moving to an absolutely strange place to which the user has never moved, there is no medical worker who knows the user very well in the medical facility in that region in many cases. It is therefore much more difficult for the medical worker to obtain the user-specific information if such a problem arises.

Moreover, according to a method of previously sending the user-specific information to the medical facility in a destination of the movement and using this user-specific information when the user undergoes a medical examination, large loads occur on both of the user and the medical facility. Namely, the user must search for the adequate medical facility located within the region in the destination of the movement and must send the user-specific information each time the user moves. Moreover, thereafter, in the case of further moving into another region, the user-specific information sent to the medical facility located in the previous region becomes unnecessary, and the user must ask the medical facility to erase this information. On the other hand, the medical facility is required to manage the user-specific information so as not to be used for purposes other than the medical care, the diagnosis and the dosage of medicine. Furthermore, if the user does not undergo the medical examination, the user-specific information is not effectively utilized, and as a result there increases a working load only for managing the user-specific information.

Further, according to a method by which the user records the user-specific information on a notebook etc beforehand and presents the notebook to the medical worker when undergoing the medical examination in the medical facility, the user himself or herself has a necessity of always carrying the recorded notebook, which accompanies a risk of being lost at all times. Moreover, in the case of forgetting to carry the notebook when going out, the user can not convey exactly the user-specific information to the medical worker when undergoing the medical examination.

It is an object of the present invention, which was devised in view of the problems described above, to get a medical facility to grasp properly the user-specific information without increasing the loads on the medical facility and on the user.

### Means for Solving the Problems

Respective modes of the present invention adopt the following configurations in order to solve the problems described above.

To accomplish the object, a user-specific information provision system including: a handheld device transmitting, to a server device, user-specific information held specifically by a user and user's biometric information acquired by measuring biometric information of the user; the server device receiving the user-specific information and the user's biometric information; and a medical facility terminal receiving information transmitted from the server device, the server device including an access point information determining unit acquiring access point information representing an access point to which the handheld device belongs at present and determining whether the access point is changed or not, at least one of the handheld device and the server device, further including a biometric information prediction determining unit determining whether or not the user's biometric information satisfies a predetermined criterion (criteria), wherein the server device transmits the user-specific information to the medical facility terminal when determining that the access point is changed and/or when determining that the predetermined criterion is satisfied.

Further, to accomplish the object, user-specific information provision method executed by a handheld device capable of transmitting, to a server device, user-specific information held specifically by a user and user's biometric information acquired by measuring biometric information of the user, the server device receiving the user-specific information and the user's biometric information, and a medical facility terminal receiving information transmitted from the server device, the method including: a step of the server device acquiring access point information representing an access point to which the handheld device belongs at present and determining whether the access point is changed or not; a biometric information prediction determining step of at least one of the handheld device and the server device determining whether the user's biometric information satisfies a predetermined criterion or not; an access point information determining step of the server device determining whether the access point is changed or not; and a step of the server device transmitting the user-specific information to the medical facility terminal when determining that the predetermined criterion is satisfied and/or when determining that the access point is changed.

Still further, to accomplish the object, a server device receiving user-specific information transmitted from a handheld device and held specifically by a user and user's biometric information acquired by measuring biometric information of the user, including: an access point information determining unit acquiring access point information representing an access point to which the handheld device belongs at present and determining whether the access point is changed or not; a biometric information prediction determining unit determining whether or not the user's biometric information satisfies a predetermined criterion; and a medical facility terminal specifying unit transmitting the user-specific information to a medical facility terminal, when determining that the access point is changed and/or when determining that the predetermined criterion is satisfied.

Yet further, to accomplish the object, a handheld device capable of transmitting, to a server device, user-specific information held specifically by a user and user's biometric information acquired by measuring biometric information of the user, the handheld device including: a biometric information prediction determining unit determining whether the biometric information satisfies a predetermined criterion or not; and a determination result transmitting unit transmitting a result of the determination to the server device when determining that the predetermined criterion is satisfied.

Moreover, to accomplish the object, a program making a computer execute: a process of receiving user-specific information transmitted from a handheld device and held specifically by a user and user's biometric information acquired by measuring biometric information of the user; a process of acquiring access point information representing an access point to which the handheld device belongs at present; a process of determining whether the access point is changed or not; a process of determining whether or not the user's biometric information satisfies a predetermined criterion; and a process of transmitting the user-specific information to the medical facility terminal when determining that the access point is changed and/or when determining that the predetermined criterion is satisfied.

According to these respective modes, even if the user falls into a comatose state due to, e.g., hypoglycaemia and reaches a state of being disabled from making mutual communications with the medical facility, the medical facility in which to install the medical facility terminal can properly grasp the sent user-specific information and, by extension, can implement a proper medical care or a proper diagnosis or a proper dosage of medicine for the user. Furthermore, new loads do not occur on both of the user and the medical facility because of obtaining these effects.

### Effects of the Invention

According to the respective modes of the present invention, the medical facility is enabled to grasp properly the user-specific information without increasing the loads on the medical facility and the user.

### BRIEF DESCRIPTION OF THE DRAWINGS

FIG. 1A is a block diagram showing an architecture of a whole use-specific information provision system 100 according to an embodiment of the present invention.

FIG. 1B is an explanatory diagram of a handheld device 110 according to the embodiment of the present invention.

FIG. 1C is an explanatory diagram of a server device 140 according to the embodiment of the present invention.

FIG. 1D is an explanatory diagram of a medical facility terminal 170 according to the embodiment of the present invention.

FIG. 2A is a diagram illustrating a data record stored in an auxiliary storage unit of the handheld device.

FIG. 2B is a diagram illustrating a database stored in an auxiliary storage unit of the server device.

FIG. 2C is a diagram illustrating the database stored in the auxiliary storage unit of the server device.

FIG. 2D is a diagram illustrating the database stored in the auxiliary storage unit of the server device.

FIG. 2E is a diagram illustrating the database stored in the auxiliary storage unit of the server device.

FIG. 2F is a diagram illustrating a database stored in an auxiliary storage unit of the medical facility terminal.

FIG. 2G is a diagram illustrating the database stored in the auxiliary storage unit of the medical facility terminal.

FIG. 2H is a diagram illustrating a database that may be stored in the handheld device.

FIG. 3 is a flowchart illustrating a biometric information profile generation process of generating a user-specific biometric information profile.

FIG. 4 is a flowchart showing a method of calculating a predictive value of prospective user's biometric information by use of the user-specific biometric information profile generated based on a past user's blood glucose level data train and determining by use of this predictive value whether the user's biometric information satisfies a predetermined criterion or not.

FIG. 5 is a diagram showing one example of fluctuation patterns (patterns 1-6) of the past biometric information.

FIG. 6 is a flowchart showing a method of updating the user-specific information stored in a user-specific information storage unit within the server device.

FIG. 7 is a flowchart showing a method of how the server device transmits the user-specific information to the necessary medical facility terminal.

FIG. 8 is a flowchart showing a method of how the server device erases the user-specific information stored in the user-specific information storage unit within the medical facility terminal.

### MODE FOR CARRYING OUT THE INVENTION

### Embodiment

A detailed description of an embodiment of the present invention will hereinafter be made with reference to the drawings. Note that the present embodiment will have a discussion by exemplifying a case of continuously measuring a blood glucose level as biometric information of a user (hereinafter referred to as user's biometric information). However, the biometric information to be measured is not limited to the blood glucose level, and available pieces of biometric information are GOT, GPT, LDH, γ-GT, alkaline phosphatase, choline esterase, lipase, creatinine-kinase and ammonia. Further, a measurement target is not limited to blood, and the measurement target may be blood sera, blood plasma, etc. Moreover, the measuring method, without being limited to the continuously measuring method, may also be a method of making the measurement per given period of time.

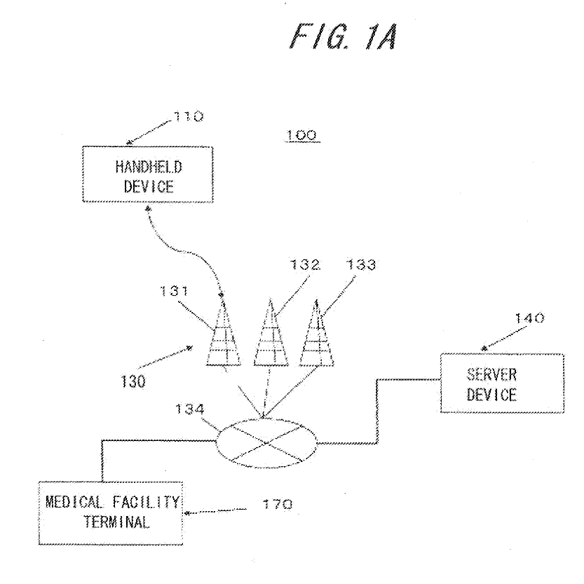

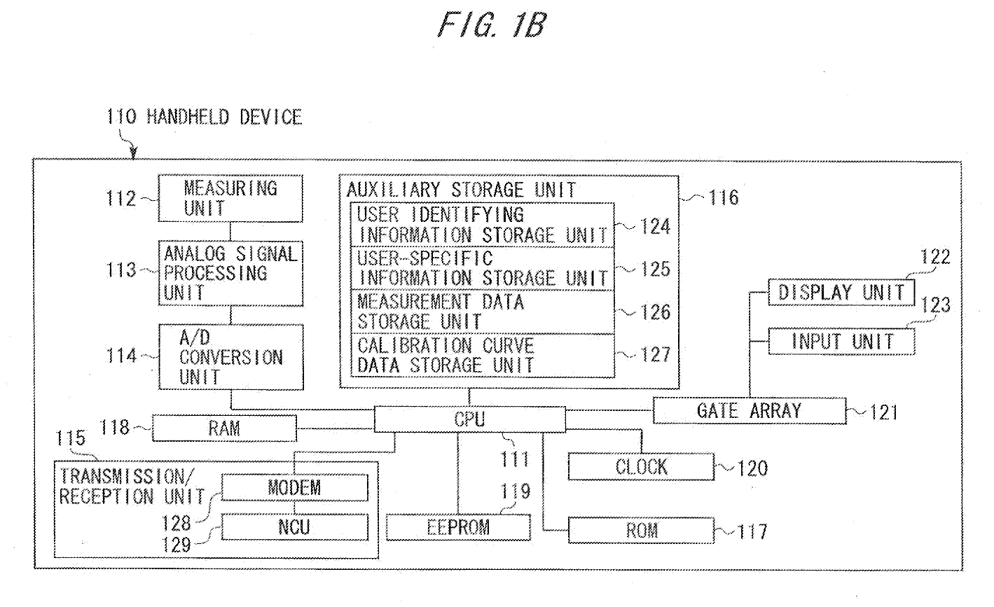

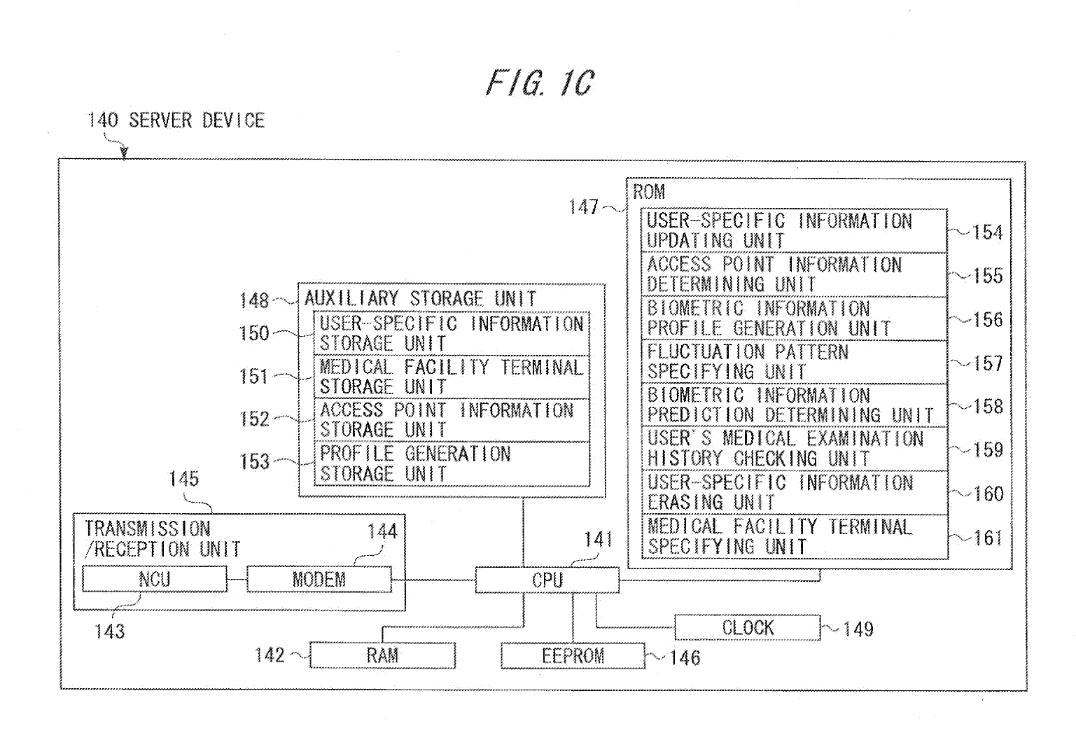

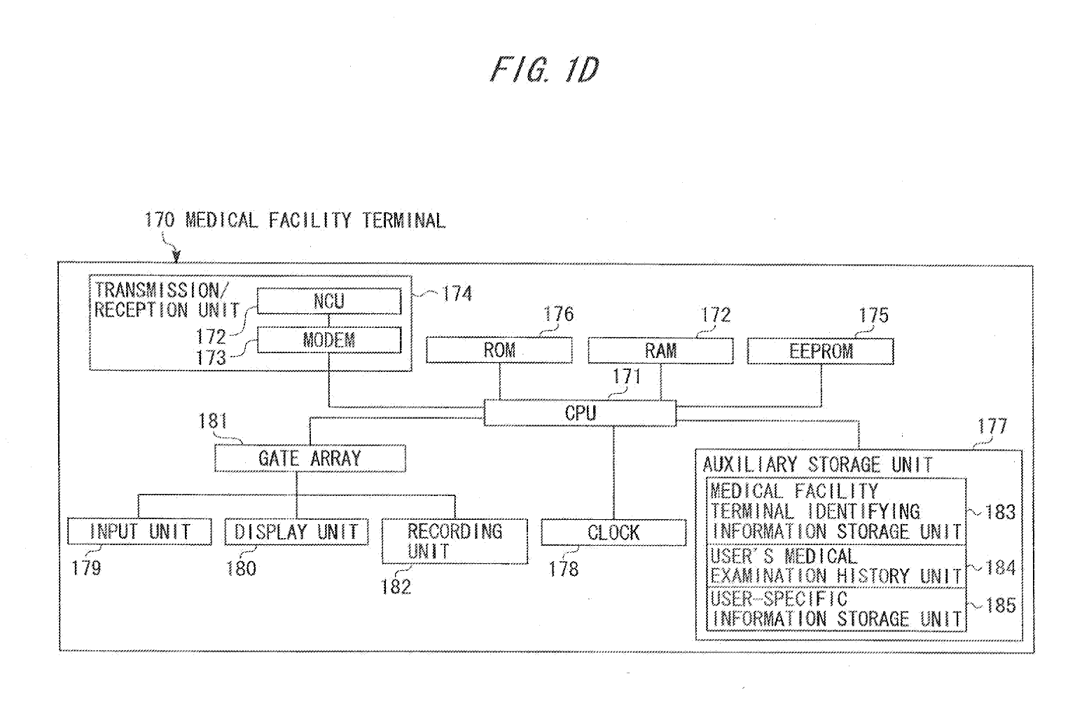

FIG. 1A is a block diagram showing a whole configuration of a user-specific information provision system 100 according to the embodiment of the present invention. The user-specific information provision system 100 is configured by a variety of devices such as a handheld device 110, access points 130, a server device 140 and a medical facility terminal 170. Configurations and characteristics of the respective devices will be described as follows.

The access points 130 are put in respective regions and communication-enabled ranges (regions) with the handheld devices 110 are set up, respectively. Then, the handheld device 110, which will be described later on, is coupled to one access point (an access point 131 in FIG. 1A) via the server device 140. The connection between the access point 130 and the handheld device 110 may be established by either a wireless system or a wired system. It is assumed that the handheld device 110 belongs to an access point 130 when the handheld device stays in the communication-enabled range with the access point 130. The connection between the access point 130 and the server device 140 may be established via a communication network 134 (such as a telephone network, the Internet and a satellite channel) and may also be established directly. Further, the access point 130 is provided with an information attaching unit which links and attaches access point information to information transmitted via the access point. The access point information is defined as information to identify individual access point, and is expressed by, for example, a number, a symbol, and the like. Note that the three access points, the access point 131, the access point 132 and the access point 133 exist in FIG. 1A, however, the number of the access points 130 is not limited to “3”, and some other plural number of access points 130 may be adopted.

The handheld device 110 includes, as will hereinafter be explained, configuration of a computer. The handheld device 110 includes a CPU 111 which controls the handheld device 110 on the whole. The CPU 111 executes a variety of processes in accordance with instructions of various programs stored in a RAM 118. A measuring unit 112, an analog signal processing unit 113 which amplifies an output signal of the measuring unit 112, an A/D conversion unit 114 which converts the output signal given from the analog signal processing unit 113 into a digital signal, a transmission/reception unit 115 which transmits and receives the data to and from the outside, an auxiliary storage unit 116, a ROM 117 storing the various programs, the RAM 118 storing various items of data processed by the CPU 111 and the programs stored in the ROM 117, an EEPROM 119 storing flags and the like, a clock 120, a gate array 121 which controls an input/output (a display unit 122, an input unit 123) to/from the CPU 111, the display unit 122 and the input unit 123 connected to the gate array 121 are coupled to the CPU 111 via bus lines.

Moreover, the auxiliary storage unit 116 is further constructed of a user identifying information storage unit 124, a user-specific information storage unit 125, a measurement data storage unit 126 and a calibration curve data storage unit 127. The auxiliary storage unit 116 involves using a hard disk and a flash memory but is not limited to these devices. Note that the handheld device 110 is preferably a portable device which can be carried solely by the user but is not limited to this portable device. The measuring unit 112 detects an in-vivo change of the user as a signal. For example, as described in Japanese National Publication of International Patent Application No. 2004-520898, a measuring device is exemplified that the signals representing the blood glucose levels are continuously captured by a blood glucose level sensor inserted into user's body, a skin of an arm region, an abdomen region, etc. via an insertion needle. Note that the measuring device is not limited to the above-mentioned measuring device. For example, as described in Japanese Publication of Examined Application No. Hei08-20412, a measuring device having a type using a disposable blood glucose level sensor is available. The disposable blood glucose level sensor detects a signal representing a blood glucose level by suction of blood bled on a surface of a fingertip, an abdomen region or an arm region by puncture thereof with a puncture needle performed per measurement. The signal representing the in-vivo change of the user, which is output from the measuring unit 112, is amplified by the analog signal processing unit 113, converted into the digital signal by the A/D conversion unit 114 and transmitted to the CPU 111.

The CPU 111 refers to the calibration curve data stored in the calibration curve data storage unit 127 of the auxiliary storage unit 116, then converts the output signal into a constituent concentration and displays a concentration value as measurement data on the display unit 122. In addition, the CPU 111 acquires date/time information from the clock 120 and stores the acquired date/time information and the measurement data associated with the acquired date/time information as user's biometric information in the measurement data storage unit 126. The transmission/reception unit 115 configuring a transmission/reception unit is coupled with a modem 128 and a communication circuit (NCU (Network Control Unit)) 129 and performs network controls. Further, the modem 128 demodulates the reception data and modulates the transmission data.

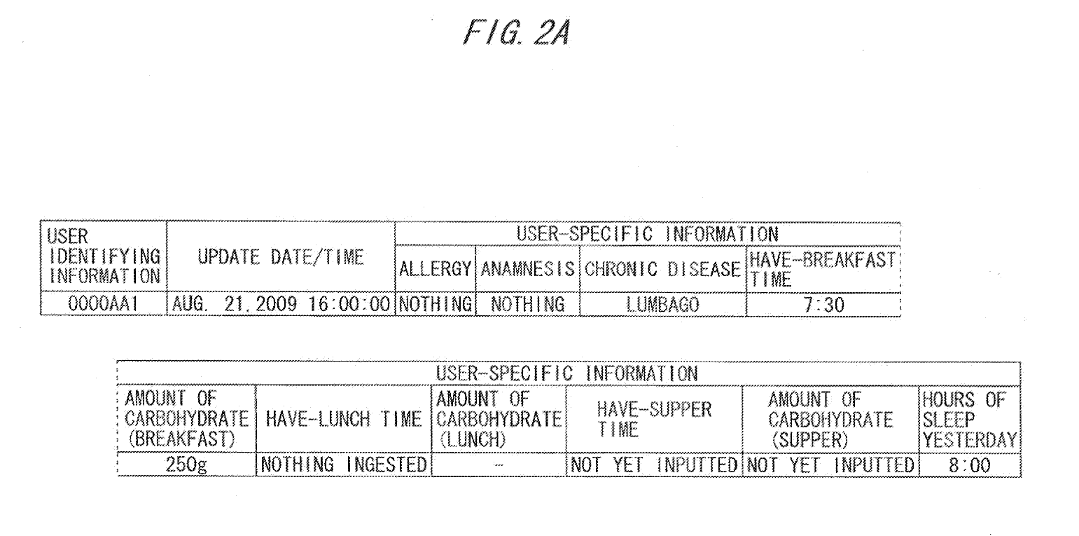

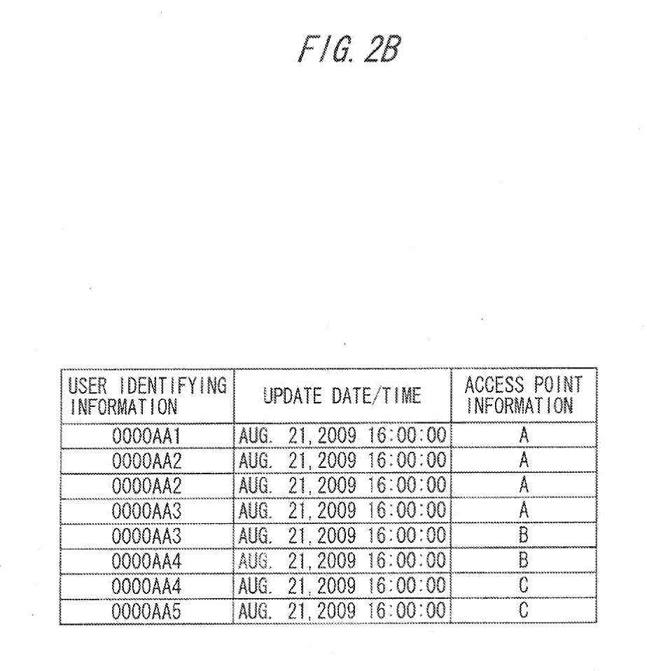

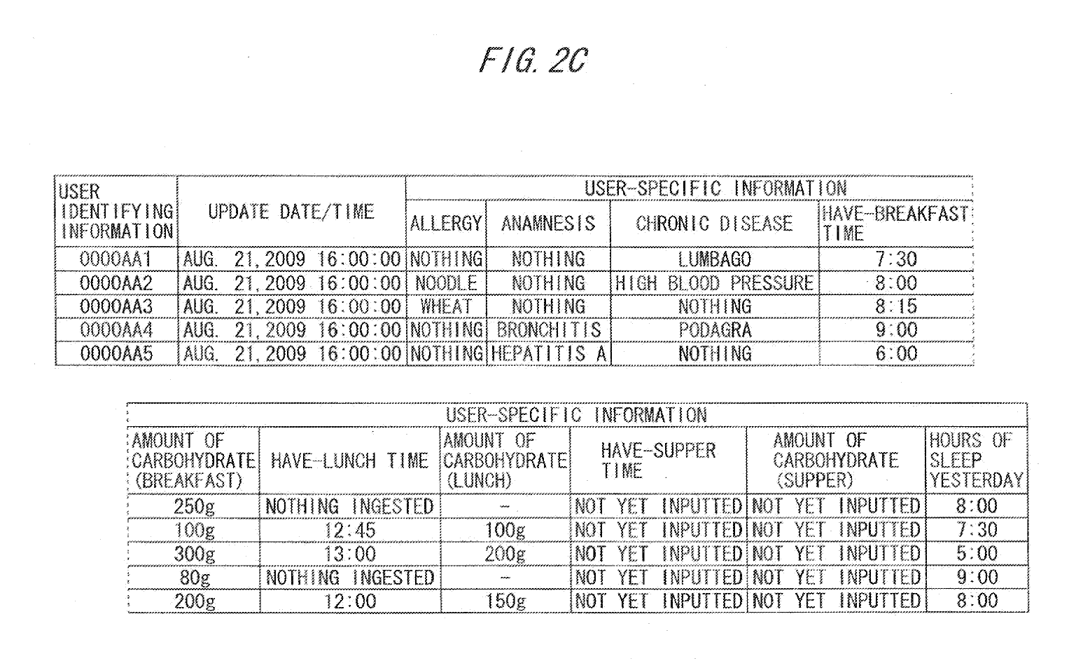

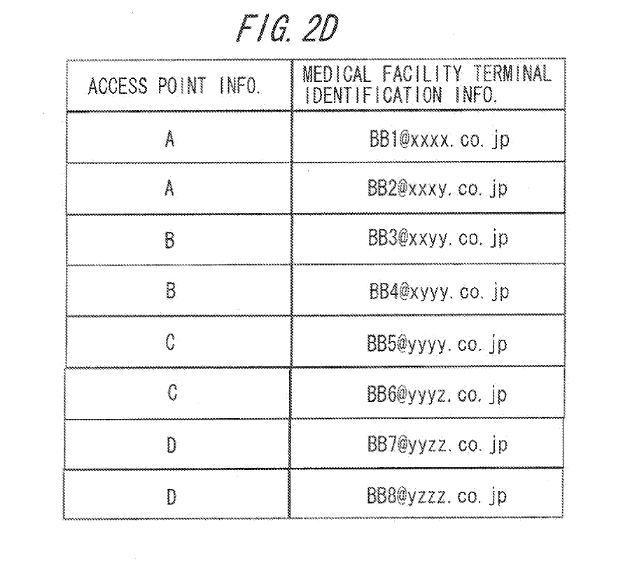

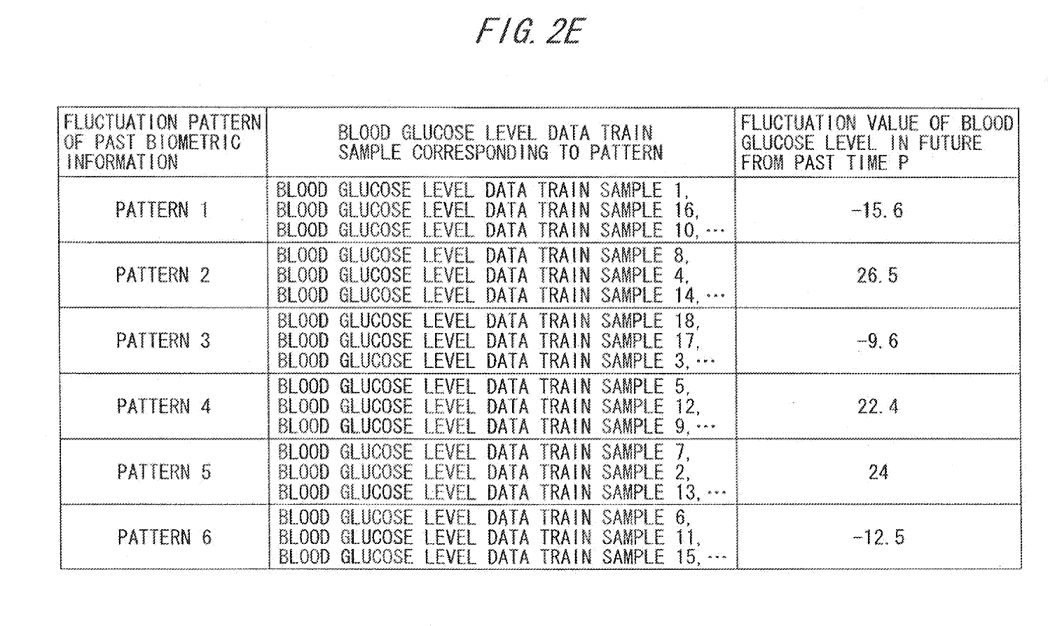

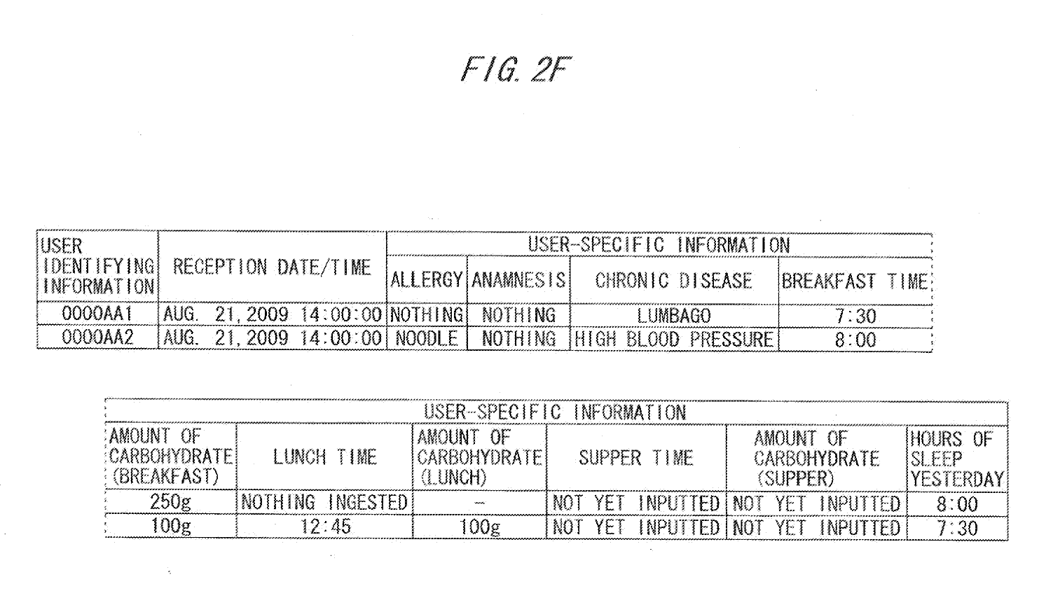

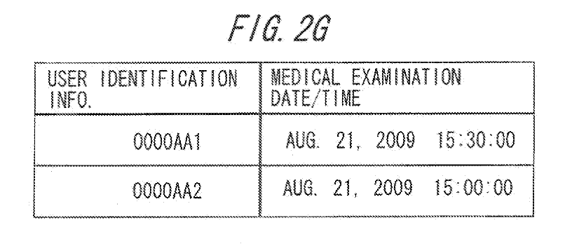

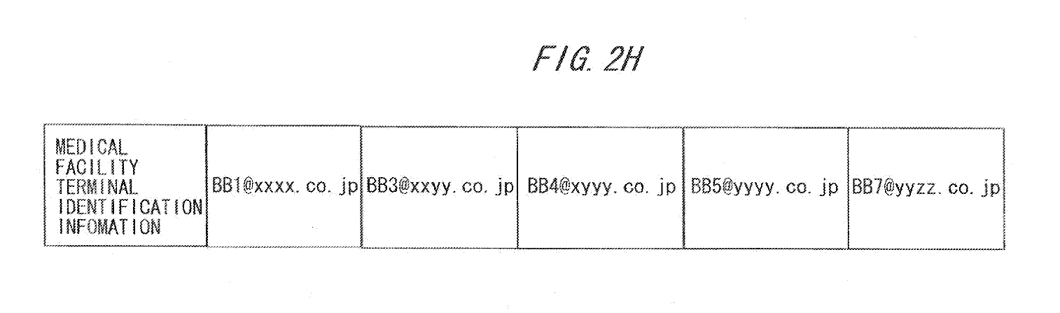

The user identifying information storage unit 124 stores with the user identifying information. Note that the user identifying information is a piece of information which enables identification of the user himself or herself using the handheld device or a piece of information enabling identification of the handheld device 110 itself, and is exemplified such as an ID number, a barcode, a QR code, a two-dimensional code and a manufacturing number. Note that a means for displaying the user identifying information on the handheld device 110 may take not only a mode of displaying the user identifying information on the display unit but also a mode of pasting the user identifying information onto the surface of a housing of the handheld device 110. The user-specific information storage unit 125 is one record that user-specific information, user identifying information of the handheld devices 110 and update time (which is the date/time information acquired from the clock) associated with the user-specific information is stored. FIG. 2A illustrates an example of this record. In the example of FIG. 2A, the user-specific information has contents of respective fields such as a “have-breakfast-time” field, a “have-lunch-time” field, a “have-supper-time” field, “amount-of-carbohydrate” fields for breakfast, lunch and supper, an “allergy” field, an “anamnesis” field and a “chronic disease” field but is not limited to these contents. The user-specific information may be updated corresponding to an option of the user, or alternatively such a mode may also be taken that the CPU 111 periodically generates an alarm on the display unit by use of the date/time information acquired from the clock 120 and prompts the user to perform these updating operations. If the user updates the data, upon inputting the update contents in the respective fields to the input unit, the CPU 111 refers to the fields of the user-specific information storage unit 125 and thus updates the data according to the update contents inputted to the input unit.

The server device 140 includes a configuration of the computer as will be described below. The server device 140 is equipped with a CPU 141 which controls the server device on the whole. The CPU 141 executes a variety of processes in accordance with instructions of various categories of programs stored in a RAM 142. Components connected via buses to the CPU 141 are a transmission/reception unit 145 constructed of a NCU 143 and a modem 144, an EEPROM 146 stored with flags and the like, a ROM 147 stores various programs, the RAM 142 stores various items of data processed by the CPU 141 and the programs stored in the ROM 147, an auxiliary storage unit 148 and a clock 149. The NCU 132 configuring a transmission/reception unit connects with the modem 144 and a communication circuit and performs network controls. Further, the modem 144 demodulates the reception data and modulates the transmission data.

Moreover, the auxiliary storage unit 148 is further constructed of databases such as a user-specific information storage unit 150, a medical facility terminal storage unit 151, an access point information storage unit 152 and a profile generation storage unit 153. The auxiliary storage unit 148 involves using the hard disk and the flash memory but is not limited to these devices. The access point information storage unit 152 is the database in which the user identifying information of individual handheld device 110, the access point information and the update time (the date/time information acquired from the clock) are associated with each other in order to grasp the access point 130 to which each handheld device 110 belongs at the present. FIG. 2B illustrates an example of this database. The user-specific information storage unit 150 is the database in which pieces of user identifying information of the individual handheld devices 110, the update time (the date/time information acquired from the clock) and pieces of user-specific information of the users who use the individual handheld devices 110 are associated with each other. FIG. 2C illustrates this database. The medical facility terminal storage unit 151 is the database in which identifying information of the medical facility terminal that will be described later on and the access point information are associated each other in order for each access point 130 to grasp the medical facility terminal 170 located in the communication-enabled range with the handheld device 110. FIG. 2D shows this database. Note that each of the access points 131-133 does not necessarily have to store all of the medical facility terminals 170 located within the communication-enabled range with the handheld device 110 but may store at least one single medical facility terminal 170 which performs the most proper treatment in the region concerned.

Further, the ROM 147 is constructed of a user-specific information updating unit 154, an access point information determining unit 155, a biometric information profile generation unit 156, a fluctuation pattern specifying unit 157, a biometric information prediction determining unit 158, a user's medical examination history checking unit 159, a user-specific information erasing unit 160 and a medical facility terminal specifying unit 161. The user-specific information updating unit 154 is stored with a program enabling execution of a process of comparing the user-specific information transmitted from the handheld device 110 with the user-specific information stored in the user-specific information storage unit 150 and, if different, updating the user-specific information stored in the user-specific information storage unit 150 of the server device 140 into the user-specific information transmitted from the handheld device 110. The access point information determining unit 155 is stored with a program enabling the execution of a process of determining, based on the access point information periodically transmitted from the access point 130 and indicating the access point to which the individual handheld device belongs at the present, whether the belonging access point is changed or not and a process of updating, when changing the access point to which the handheld device 110 belongs, the access point information, stored in the access point information storage unit 152, of the handheld device 110 into the access point information indicating the now-belonging access point by referring to the access point information storage unit 152.

The biometric information profile generation unit 156 stores a program that is enabling execution of a process to generate a biometric information profile specific to the user based on a past user's blood glucose level data column (defined as user's biometric information transmitted in the past from the handheld device) accumulated at a predetermined time period, and to store the biometric information profile specific to the user, as a database (shown in FIG. 2E), in the profile generation storage unit 153 provided in the auxiliary storage unit 148. The fluctuation pattern specifying unit 157 stores a program that is enabling execution of a process to specify a fluctuation pattern of the past user's biometric information, which is coincident with a fluctuation pattern of user's recent biometric information, among the user-specific information profiles stored in the profile generation storage unit 153. The biometric information prediction determining unit 158 stores a program that is enabling execution of a process to calculate a predictive value of the prospective user's biometric information that is obtained by adding a fluctuation value of the prospective user's biometric information associated with the fluctuation pattern, specified by the fluctuation pattern specifying unit 157, of the past user's biometric information to the user's present biometric information, and to determine by using this predictive value of the prospective user's biometric information whether the user's biometric information satisfies a predetermined criterion or not.

The user's medical examination history checking unit 159 executes a process to determine whether or not the user undergoes the medical examination in the medical facility that the medical facility terminal 170, which will be described later on, is installed. To be specific, the user's medical examination history checking unit 159 stores a program that is enabling execution of a process to specify user's medical examination date/time stored in a user's reception history unit 184 provided in an auxiliary storage unit 177 of the medical facility terminal 170 that will be explained later on and to specify reception date/time of the user-specific information stored in a user-specific information storage unit 185 provided similarly in the auxiliary storage unit 177, and to determine, if the medical examination date/time is posterior to the reception date/time, that the user undergoes the medical examination. The user-specific information erasing unit 160 stores a program that is enabling execution of a process to erase the user identifying information stored in the user-specific information storage unit 185 provided in the auxiliary storage unit 177 of the medical facility terminal 170 that will be described later on, all items of information (the reception date/time, the user-specific information) associated with the respective pieces of user identifying information, the user identifying information stored in a user's medical examination history unit 184 provided similarly in the auxiliary storage unit 177 and the user's medical examination date/time associated with the user identifying information. The medical facility terminal specifying unit 161 stores a program that is enabling execution of a process to specify the medical facility terminal 170 from medical facility terminal recognizing information associated with access point information, which is stored in the medical facility terminal storage unit 151, indicating an access point to which individual handheld device 110 currently belongs, and to transmit the user-specific information to the thus-specified medical facility terminal 170.

The medical facility terminal 170 includes a configuration of the computer as will hereinafter be explained. The medical facility terminal 170 is equipped with a CPU 171 which controls the medical facility terminal 170 on the whole. The CPU 171 executes a variety of processes in accordance with instructions of various programs stored in a RAM 172. A transmission/reception unit 174 constructed of a NCU 172 and a modem 173, an EEPROM 175 storing flags and the like, a ROM 176 storing various programs, a RAM 172 storing various items of data processed by the CPU 171 and the programs stored in the ROM 176, an auxiliary storage unit 177, a clock 178, a gate array 181 which controls an input and an output (an input unit 179, a display unit 180) to/from the CPU 171, i.e., the display unit 180, the input unit 179 and a recoding unit 182 that are coupled to the gate array 181 are coupled to the CPU 171 via bus lines. The medical facility terminal 170 is provided within the medical facility. The medical facility is not limited to a permanent facility such as a hospital and a clinic. The medical facility may also be a movable facility such as an ambulance when taking account of a case where the user falls into a comatose state due to hypoglycaemia and is carried to the permanent facility such as the hospital and the clinic, during which the user-specific information is required. The NCU 172 configuring the transmission/reception unit 174 connects with the modem 173 and the communication circuit and performs network controls. Further, the modem 173 demodulates the reception data and modulates the transmission data. Moreover, the auxiliary storage unit 177 is further constructed of databases such as a medical facility terminal identifying information storage unit 183, a user's medical examination history unit 184 and a user-specific information storage unit 185. The auxiliary storage unit 177 involves using the hard disk and the flash memory but is not limited to these devices.

The medical facility terminal identifying information storage unit 183 stores the medical facility terminal identifying information. Note that the medical facility terminal identifying information is defined as the identifying information allocated to each medical facility terminal 170 and involves using, for example, a mail address of the medical facility terminal 170. The user-specific information storage unit 185 is a database in which pieces of user identifying information, which is received from the server device, of the individual handheld devices 110 and pieces of user-specific information are associated together with the reception date/time (the date/time information is acquired from the clock, hereinafter referred to as reception date/time) thereof. FIG. 2F illustrates this database. The user's medical examination history unit 184 is a database that the user identifying information inputted by the input unit 179 is associated with inputted date/time (the date/time information is acquired from the clock, hereinafter referred to as medical examination date/time). FIG. 2G illustrates this database. The input unit 179 is a device to input the user identification information, which is displayed on the display unit 112 of the handheld device 110 or is attached to the handheld device, to the medical facility terminal 170 when the user using the handheld device 110, to take medical examination, goes to the medical facility that the medical facility terminal 170 is installed or the user having the handheld device 110 is carried to the medical facility, and may also be a barcode-reader-based reading device and a device which inputs the user-specific information by a keyboard and the like. The display unit 180 displays the user identifying information and the user-specific information and is constructed of, for example, a liquid crystal screen and the like.

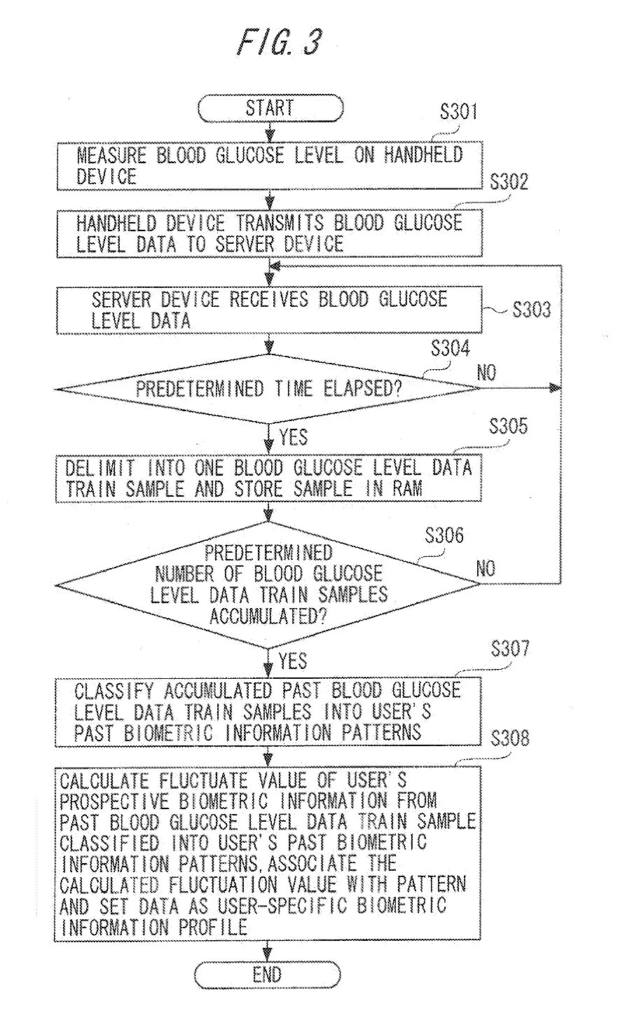

Explained next with reference to FIGS. 3, 4 and 5 is a method that the server device 140 or the handheld device 110 stores the user-specific information, then calculates the predictive value of the prospective user's biometric information and determines, by using it, whether the user's biometric information satisfies the predetermined criterion or not. Note that the discussion will be made by exemplifying a case of measuring the blood glucose level as the user's biometric information.

First, a biometric information profile generation process to generate a biometric information profile specific to the user will be described according to a flowchart in FIG. 3.

The measuring unit 112 of the handheld device 110 measures the blood glucose level of the user as the user's biometric information, and continuously acquires the blood glucose level data (step S301). The operation of acquiring the blood glucose level data may be performed based on an arbitrary instruction of the user and may also take a mode of being performed automatically periodically by the handheld device 110.

Next, the transmission/reception unit 115 of the handheld device 110 transmits, to the server device 140, the user's blood glucose level data that are continuously acquired by the measuring unit 112 (step S302). Subsequently, when the transmission/reception unit 145 of the server device 140 starts receiving the continuously-acquired blood glucose level data of the user, which are transmitted from the handheld device 110, the CPU 141 executes a process of reading the program stored in the biometric information profile generation unit 156 included in the ROM 147 into the RAM 142 and continuing to store the continuously-received blood glucose level of the user in the RAM 142 (step S303).

Next, the CPU 141, after starting continuously storing the blood glucose level data of the user in the RAM 142 in step S303, determines whether a predetermined period of time elapses or not (step S304). If it is determined that the predetermined period of time does not elapse (S304; NO), the CPU 141 loops the processing back to step S303. Whereas if it is determined that the predetermined period of time elapses (S304; YES), the CPU 141 delimits, as one blood glucose level data column sample, the user's blood glucose level data that are continuously stored in the RAM 142, and stores again (step S305).

Subsequently, the CPU 141 determines whether a predetermined number of blood glucose level data column samples are stored in the RAM 142 or not (step S306). When determining that the predetermined number of samples are not yet stored (S306; NO), the CPU 141 loops the processing back to step S303, and stores a new blood glucose level data column sample in the RAM 142 within the processes down to step S305. While on the other hand, when determining that the predetermined number of blood glucose level data column samples are stored therein (S306; YES), the CPU 141 proceeds the processing to step S307.

Next, in step S307, the CPU 141 executes at first a process of calculating a deviation rate of the blood glucose level, a variation rate of the blood glucose level and a difference of the blood glucose level shown in the blood glucose level data columns anterior to past time P with respect to each of the predetermined number of blood glucose level data column samples (representing the user's biometric information in the past). Note that the past time P represents the time P counted past from each point of the latest time, which is contained in each blood glucose level data column sample. Hereafter, it is shown that is a concrete calculation method of calculating the deviation rate of the blood glucose level, the variation rate of the blood glucose level and the difference of the blood glucose level.

The deviation rate of the blood glucose level is calculated by the following formula (1), where DATAp is a blood glucose level at the past time P, and DATAf is an average value of the blood glucose levels during a period of time having a predetermined length anterior A-hours to the past time P.

(DATAp−DATAf)/DATAf×100 (Formula 1)

The variation rate of the blood glucose level is calculated by the following formula (2), where DATAk is an average value of the blood glucose levels during a period of time having a predetermined length anterior to the past time P, and DATAf is the average value of the blood glucose levels during a period of time having a predetermined length anterior A-hours to the past time P.

(DATAf−DATAk)/A (Formula 2)

The difference of the blood glucose level is calculated by the following formula (3), where DATAp is the blood glucose level at the past time P, and DATAa is a blood glucose level anterior A-hours to the past time P.

DATAp−DATAa (Formula 3)

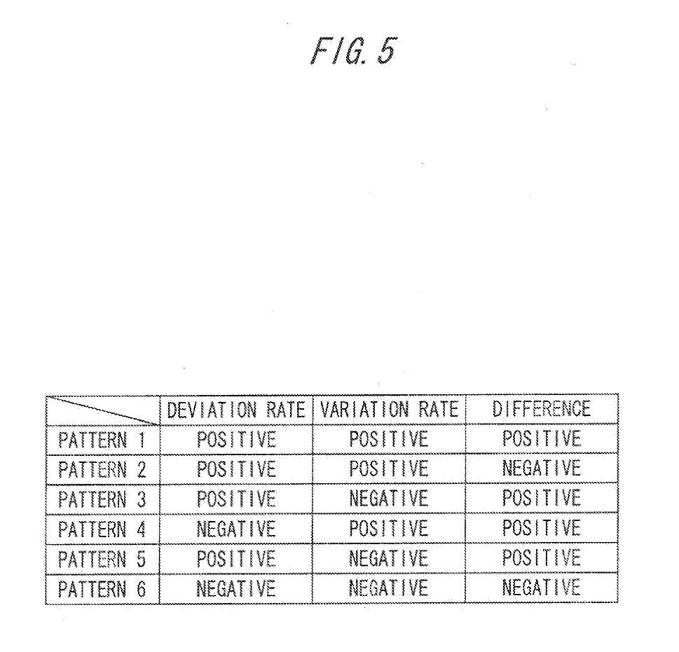

Next, the CPU 141 executes a process of calculating the deviation rate of the blood glucose level (Formula 1), the variation rate of the blood glucose level (Formula 2) and the past blood glucose level based on the difference of the blood glucose level (Formula 3) with respect to each of the predetermined number of stored blood glucose level data column samples as described above, and thereafter determining which pattern among patterns 1-6 (each representing a fluctuation pattern of the user's biometric information in the past) as illustrated in FIG. 5 that each of the blood glucose level data column samples is applied to (step S307). The CPU 141, after this determination process, proceeds the processing to step S308.

Next, in step S308, the CPU 141 transforms, into a frequency distribution, the fluctuation values of the blood glucose levels posterior X-hours to the past time P, which are indicated by the individual blood glucose level data column sample with respect to each of the patterns 1-6 (each representing a fluctuation pattern of the user's biometric information in the past) to which the blood glucose level data column sample is applied, and sets a median thereof as the fluctuation value of the blood glucose level in the future from the past time P (representing the fluctuation value of the user's biometric information in the future). Note that as for the calculation of the fluctuation values, other than the median described above, there may also be taken an average value of the fluctuation values of the blood glucose level posterior X-hours to the past time P. The CPU 141 generates the biometric information profile specific to the user, in which the thus-acquired fluctuation pattern of the past user's biometric information is associated with the fluctuation values of the blood glucose level in the future from the time P when that fluctuation pattern occurs (which represent the fluctuation values of the user's biometric information in the future), and stores the biometric information profile in a format of a database as illustrated in FIG. 2E in the profile generation storage unit 153 provided in the auxiliary storage unit 148 (step S308). Thereafter, the CPU 141 erases the program read from the biometric information profile generation unit 156 that is stored in the RAM 142, to terminate the processing.

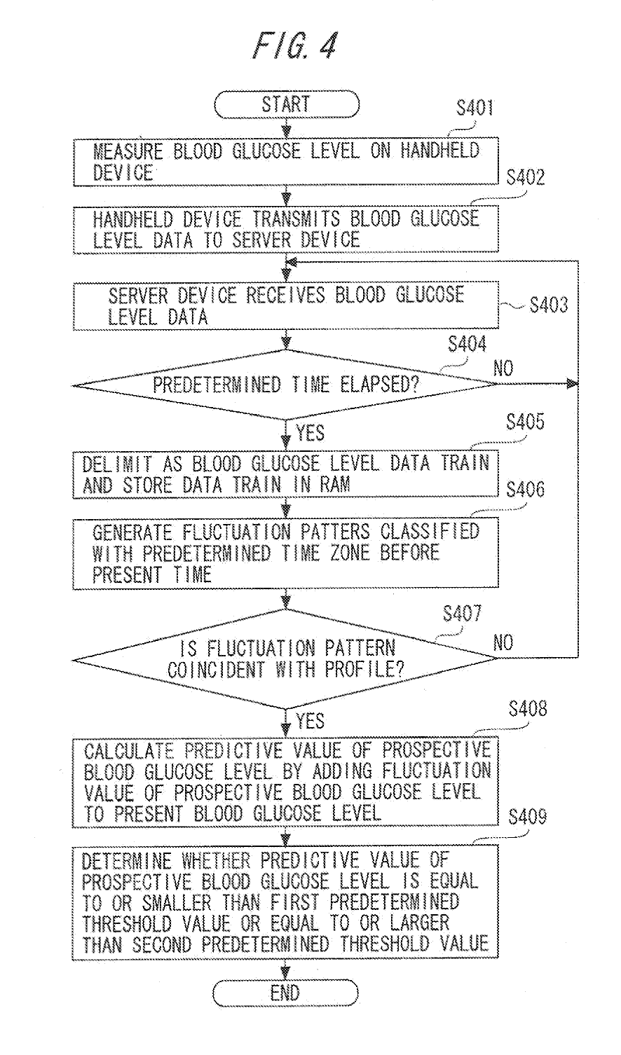

Explained next with reference to a flowchart in FIG. 4 is a method of calculating the predictive value of the prospective user's biometric information by using the user-specific biometric information profile generated based on the past user's blood glucose level data column as described above, and determining, by using it, whether the user's biometric information satisfies the predetermined criterion or not.

The measuring unit 112 of the handheld device 110 measures the blood glucose level of the user as the user's biometric information, and continuously acquires the blood glucose level data (step S401). The operation of acquiring the blood glucose level data may be performed based on the arbitrary instruction of the user and may also take the mode of being performed automatically periodically by the handheld device 110.

Next, the transmission/reception unit 115 of the handheld device 110 transmits, to the server device 140, the user's blood glucose level data that are continuously acquired by the measuring unit 112 (step S402). Subsequently, the transmission/reception unit 145 of the server device 140 starts receiving the continuously-acquired user's blood glucose level data transmitted from the handheld device 110, then the CPU 141 executes a process of reading the program stored in the fluctuation pattern specifying unit 157 provided in the ROM 147 into the RAM 142 and continuing to store the continuously-received user's blood glucose level data in the RAM 142 (step S403).

Next, the CPU 141 determines whether or not a predetermined period of time elapses since the start of continuously storing the user's blood glucose level data in the RAM 142 in step S403 (step S404). When determining that the predetermined period of time does not elapse, the CPU 141 loops the processing back to step S403. While on the other hand, when determining that the predetermined period of time elapses, the CPU 141 delimits, as one blood glucose level data column, the user's blood glucose level data that are continuously stored in the RAM 142, and stores in the RAM 142 again (step S405).

Next, in step S405, the CPU 141 generates the fluctuation pattern of the recent blood glucose levels (which represents the fluctuation pattern of the user's recent biometric information) based on the blood glucose level data column stored in step S405. To be specific, the CPU 141 generates the fluctuation pattern of the recent blood glucose levels (which represents the fluctuation pattern of the user's recent biometric information) including the deviation rate of the blood glucose level, the variation rate of the blood glucose level and the difference of the blood glucose level shown in the recent blood glucose level data column by the same calculation method as the method in step S307 (step S406).

Subsequently, the CPU 141 refers to the database (FIG. 2E) of the user-specific information profile stored in the profile generation storage unit 153 and thus determines whether or not the fluctuation pattern of the past user's biometric information is coincident with the fluctuation pattern of the user's recent biometric information (step S407). If determined not to be coincident in step S407 (S407; NO), the CPU 141 erases the blood glucose level data column stored in the RAM 142 and loops the processing back to step S401. Whereas if determined to be coincident in step S407 (S407; YES), the CPU 141 erases the program read from the fluctuation pattern specifying unit 157 that is stored in the RAM 142, and reads the program stored in the biometric information prediction determining unit 158 provided in the ROM 147 into the RAM 142. Then, the CPU 141 executes a process of referring to the database (FIG. 2E) of the user-specific biometric information profile and calculating the predictive value of the blood glucose level in the future (which represents the predictive value of the user's biometric information in the future) by adding the fluctuation value of the blood glucose level in the future from the time P (which represents the fluctuation value of the user's biometric information in the future) associated with the fluctuation pattern of the past user's biometric information coincident therewith to the present blood glucose level (step S408).

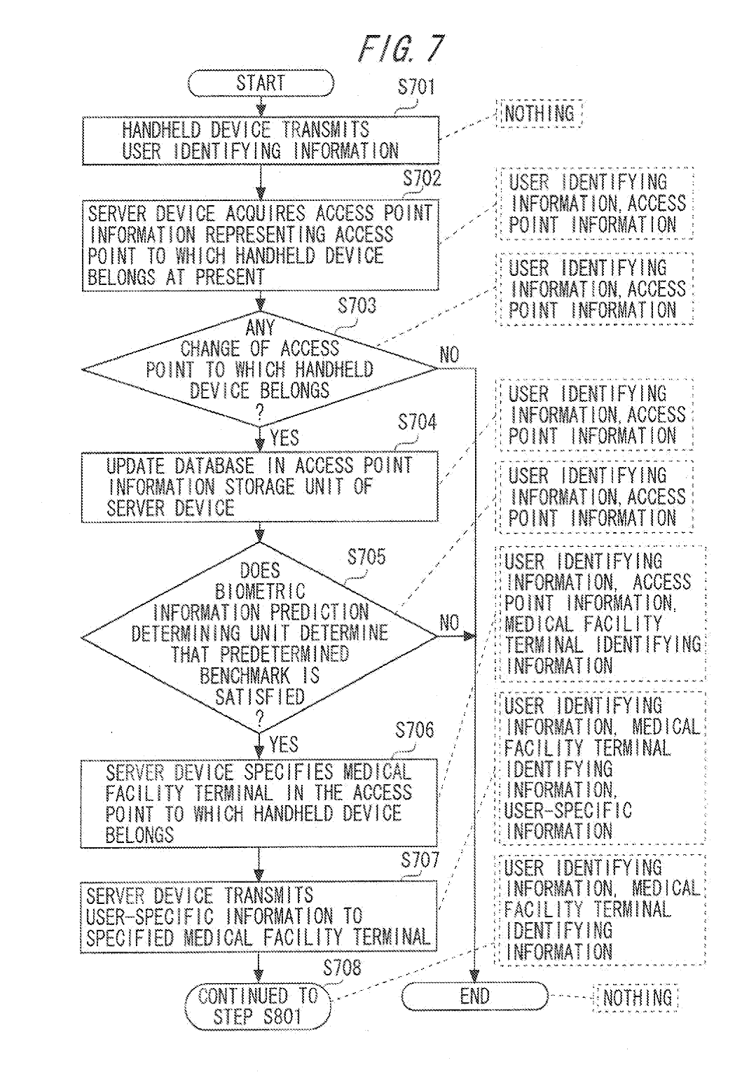

Next, the CPU 141 determines whether or not the calculated predictive value of the prospective blood glucose level is equal to or smaller than a first predetermined threshold value which is predetermined corresponding to the user, thereby determining whether the user will fall into the hypoglycaemic state or not. In this case, the CPU 141, if equal to or smaller than the first predetermined threshold value, deems that the user will fall into the hypoglycaemic state and therefore determines that the blood glucose level satisfies the predetermined criterion. Then, the CPU 141 erases the program read from the biometric information prediction determining unit 158 that is stored in the RAM 142, and advances the processing to step S706 (FIG. 7) as will be described later on. Alternatively, such a scheme may also be taken that the CPU 141 determines whether or not the calculated predictive value of the prospective blood glucose level is equal to or larger than a second predetermined threshold value which is predetermined corresponding to the user, thereby determining whether the user will fall into a hyperglycaemic state or not. In this case, the CPU 141, if equal to or larger than the second predetermined threshold value, deems that the user will fall into the hyperglycaemic state, and therefore determines that the blood glucose level satisfies the predetermined criterion. Then, the CPU 141 erases the program read from the biometric information prediction determining unit 158 that is stored in the RAM 142, and advances the processing to step S706 (FIG. 7) as will be described later on (step S409).

Further, the biometric information profile generation unit 156, the fluctuation pattern specifying unit 157 and biometric information prediction determining unit 158 are employed for predicting the prospective blood glucose level by using the calculation method described above and determining based on this whether the predetermined criterion is satisfied or not, however, the method is not limited to the calculation method described above. For example, the method of predicting the prospective blood glucose level may involve using a method described in Japanese Patent Laid-Open Publication No. 2005-308742.

Further, the determination method may involve not only the determination based on the above-calculated prospective blood glucose level but also the determination based on the present blood glucose level. For instance, an available scheme is that the biometric information prediction determining unit 158 sets the first predetermined threshold value that is predetermined corresponding to the user and determines, if the present blood glucose level is equal to smaller than the first predetermined threshold value, that the blood glucose level satisfies the predetermined criterion. Alternatively, there is taken another available scheme of setting the second predetermined threshold value, which is predetermined corresponding to the user, and, if the present blood glucose level is equal to or larger than the second predetermined threshold value, determining that the blood glucose level satisfies the predetermined criterion.

Moreover, the determination method may involve not only the determination based on the calculated prospective blood glucose level or based on the present blood glucose level but also the determination based on a rising speed or a lowering speed of the present blood glucose level (both of speeds are obtained from the present blood glucose level and the immediate blood glucose level). For example, an available scheme is that the biometric information prediction determining unit 158 sets a first speed threshold value which is predetermined corresponding to the user and, if the lowering speed of the present blood glucose level is equal to or smaller than the first speed threshold value, determines that the blood glucose level satisfies the predetermined criterion. Moreover, there may be taken another available scheme of setting the second predetermined threshold value which is predetermined corresponding to the user and, if the rising speed of the present blood glucose level is equal to or larger than this second predetermined threshold value, determining that the blood glucose level satisfies the predetermined criterion.

Incidentally, such a mode may also be adopted that the biometric information profile generation unit 156, the fluctuation pattern specifying unit 157, the biometric information prediction determining unit 158 and the profile generation storage unit 153 are stored in not the server device 140 but the ROM 117 of the handheld device 110 (the biometric information profile generation unit 156 is stored in the auxiliary storage unit 116 of the handheld device 110), and the CPU 111 of the handheld device 110 reads the various programs stored in the ROM 117 into the RAM 118 and executes the same process as the process of the CPU 141 of the server device 140 explained in FIGS. 3 and 4. In this case, the handheld device 110 further stores newly, in the ROM 117, a determination result transmitting unit (which is not illustrated in FIG. 1B) containing a program enabling the execution of a process of transmitting, if the user's biometric information is determined to satisfy the predetermined criterion in step S409, a result of being determined to satisfy the criterion to the server device 140. Then, if the user's biometric information is determined to satisfy the predetermined criterion in step S409, the CPU 111 of the handheld device 110 reads the program stored in the determination result transmitting unit provided in the ROM 117 into the RAM 118, and transmits the result of being determined to satisfy the criterion to the server device 140. The server device 140 advances, based on the result of this determination, the processing to step S706 (FIG. 7) as will be mentioned later on. Furthermore, the determination result transmitting unit may be enabled to execute a process of further transmitting, simultaneously with the result of the determination, the data record (FIG. 2A) indicating the user-specific information stored in the user-specific information storage unit 125 to the server device 140. This mode being adopted, only if the user's biometric information satisfies the predetermined criterion, the user-specific information is transmitted to the server device 140, which therefore leads to a decrease in processing load of the server device.

The processing result of the user's biometric information in the server device 140 or the handheld device 110 can be, as will be described later on with reference to the flowchart in FIG. 7, used as a criterion for determining whether or not the server device 140 transmits the user-specific information to the necessary medical facility terminal 170.

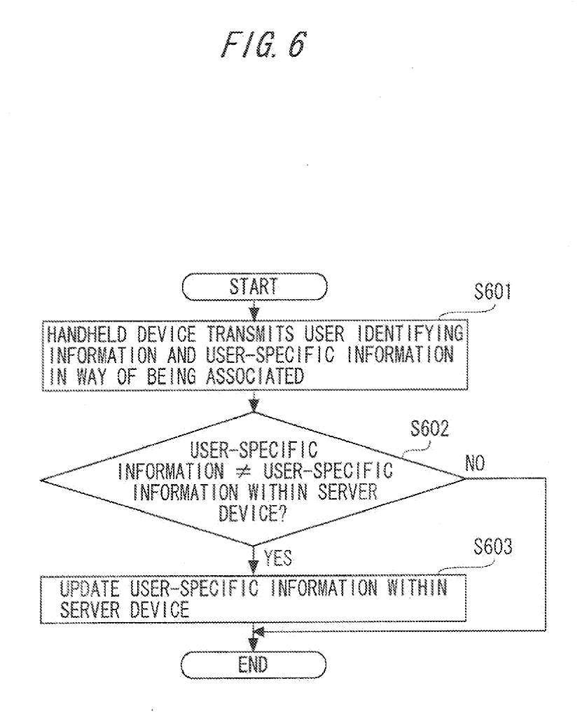

Next, a method by which the server device 140 updates the user-specific information stored in the user-specific information storage unit 150 within this server device 140, will be described with reference to a flowchart in FIG. 6.

The CPU 111 of the handheld device 110 transmits the data record (FIG. 2A) stored in the user-specific information storage unit 125 to the server device 140. This transmitting operation may take a mode that the user arbitrarily instructs the CPU 111 to transmit the data record via the input unit 123 and may also take a mode that the CPU 111 periodically automatically transmits the data record. Alternatively, there may be taken still another mode that the user inputs the latest user-specific information to the handheld device 110, and the CPU 111 automatically transmits this user-specific information to the server device 140 simultaneously with updating the user-specific information storage unit 125 (step S601).

Next, the CPU 141 of the server device 140 receives the data record (FIG. 2A) transmitted from the handheld device 110 and stores this data record in the RAM 142. Subsequently, the CPU 141 reads the program stored in the user-specific information updating unit 154 existing within the ROM 147 into the RAM 142 and executes the next process. At first, the CPU 141 refers to the user-specific information storage unit 150 in the server device 140 and compares the user-specific information of the data record (FIG. 2C) in the user-specific information storage unit 150 of the server device 140 with the user-specific information of the data record (FIG. 2A) transmitted from the handheld device 110 (step S602). The CPU 141, if different (S602; YES), advances the processing to step S603. Whereas if coincident (S602; NO), the CPU 141 erases the program read from the user-specific information updating unit 154, thus terminating the processing.

Subsequently, in step S603, the CPU 141 updates the user-specific information of the data record (FIG. 2C) in the user-specific information storage unit 150 of the server device 140 into the user-specific information of the data record (FIG. 2A) transmitted from the handheld device 110 (step S603). After updating, the CPU 141 terminates the processing by erasing the data record (FIG. 2A) read into the RAM 142 and the program read from the user-specific information updating unit 154.

The thus-made transmission and reception of the information between the handheld device 110 and the server device 140 enable the user-specific information held by the user to be kept in the latest status.

Next, a method by which the server device 140 transmits the user-specific information to the necessary medical facility terminal 170 will be described with reference to a flowchart in FIG. 7. Note that FIG. 7 illustrates respective steps in the way of being associated with items of data stored in the RAM 142 of the server device 140 when executing these steps of a processing flow.

The CPU 111 of the handheld device 110 periodically transmits, by way of signals, the pieces of user identifying information stored in the user identifying information storage unit 124. All of the access points 130 capable of receiving these signals transmit the signals to the server device 140 in a way that attaches pieces of access point information allocated to the individual access points and the reception intensities to the signals (step S701).

Next, the CPU 141 of the server device 140 receives the user identifying information, the access point information and the reception intensity that are transmitted via the access point 130 in step S701, and stores these items of information in the RAM 142. Subsequently, the CPU 141 reads the program stored in the access point information determining unit 155 existing in the ROM 147 into the RAM 142, and executes the following processes.

To start with, the CPU 141 compares the reception intensities transmitted from the individual access points with each other in step S701. The CPU 141 selects the access point information received at the strongest reception intensity and stores this access point information in the way of being associated with the user identifying information in the RAM 142. The CPU 141 erases, other than the thus-stored access point information, the remaining pieces of access point information and the reception intensity information as well. Through this process, the server device 140 acquires the access point information indicating the access point to which the handheld device 110 belongs at the present (step S702).

Next, the CPU 141 refers to the database (FIG. 2B) of the access point information storage unit 152 that is stored in the auxiliary storage unit 148, and searches for the user identifying information coincident with the user identifying information stored in step S702, thereby specifying the access point information associated with this user identifying information. Then, the CPU 141 compares this specified information with the access point information stored in the RAM 142. The CPU 141, if different, determines that there changes the access point to which the handheld device 110 belongs (S703; YES), and advances the processing to step S704. The CPU 141, if coincident, determines that the handheld device 110 remains belonging to the same access point (S703; NO). In this case, the CPU 141 erases the user identifying information and the access point information which are stored in the RAM 142 and the program read from the access point information determining unit 155, thereby finishing the processing.

Subsequently, the CPU 141 carries out the process of updating the access point information specified on the database (FIG. 2B) of the access point information storage unit 152 that is stored in the auxiliary storage unit 148 into the access point information stored in the RAM 142 (step S704). After updating, the CPU 141 erases the program read from the access point information determining unit 155 that is stored in the RAM 142 but makes the access point information and the user identifying information each stored in the RAM 142 remain as they are.

The CPU 141, after erasing the program read from the access point information determining unit 155 that is stored in the RAM 142 in step S704, reads next the program stored in the biometric information prediction determining unit 158 provided in the ROM 147 into the RAM 142. With this operation, the CPU 141 executes the process of determining, as described above in FIG. 4, whether the blood glucose level satisfies the predetermined criterion or not (step S705). When determining that the blood glucose level satisfies the predetermined criterion (S705; YES), the CPU 141 erases only the program read from the biometric information prediction determining unit 158 that is stored in the RAM 142 but makes the access point information and the user identifying information each stored in the RAM 142 remain as they are, and advances the processing to step S706. While on the other hand, when determining that the predetermined criterion is not satisfied (S705; NO), the CPU 141 terminates the processing by erasing the access point information and the user identifying information each stored in the RAM 142 and the program read from the biometric information prediction determining unit 158.

The CPU 141, after erasing only the program read from the biometric information prediction determining unit 158 that is stored in the RAM 142 in step S705, reads next the program stored in the medical facility terminal specifying unit 161 existing in the ROM 147 into the RAM 142. With this operation, the CPU 141 executes the process of specifying the medical facility terminal 170 located within the communication-enabled region with the access point to which the handheld device 110 belongs and transmitting the user-specific information to this specified medical facility terminal 170.

To be specific, at first, the CPU 141 refers to the database (FIG. 2D) of the medical facility terminal storage unit 151 that is stored in the auxiliary storage unit 148 and searches for the access point information coincident with the access point information stored in the RAM 142 from within this database, thus specifying all pieces of medical facility terminal identifying information associated with this access point information (step S706). Next, the CPU 141 executes the process of again storing the user identifying information stored in the RAM 142 and the specified medical facility terminal identifying information in the way of being associated with each other, and, simultaneously with this storing process, erasing the access point information stored in the RAM 142.

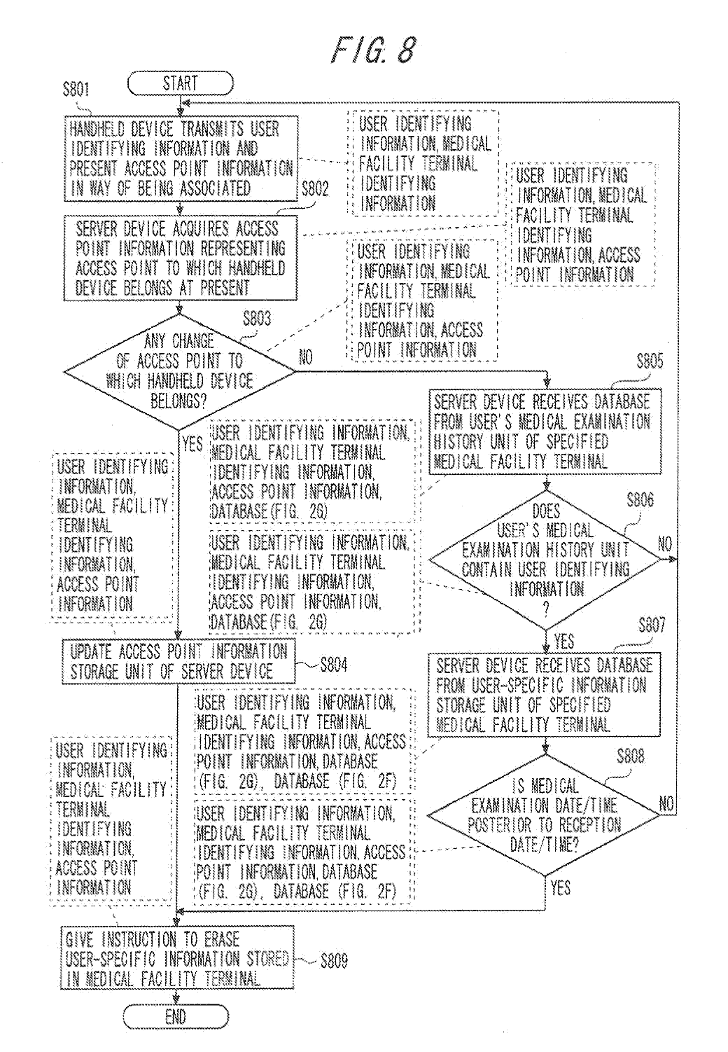

Subsequently, the CPU 141 refers to the database (FIG. 2C) of the user-specific information storage unit 150 that is stored in the auxiliary storage unit 148, and searches for the user-specific information coincident with the user-specific information stored in the RAM 142 from within this database, thereby specifying the user-specific information associated with this user identifying information. Then, the CPU 141 performs the process of further associating this specified user-specific information with the user identifying information and the medical facility terminal identifying information that are stored in the RAM 142 and again storing these associated items of information in the RAM 142. Next, the CPU 141 executes the process of transmitting these items of information in the way of being associated with each other in the RAM 142 to the medical facility terminal 170 specified by the medical facility terminal identifying information in step S706 (step S707). Note that the transmission may take a unidirectional transmission mode to the medical facility terminal 170 from the server device 140 or may also take a bidirectional transmission mode to the specified medical facility terminal 170 from the server device 140 after the CPU 171 of the medical facility terminal 170 has instructed the CPU 141 of the server device 140 to send the user-specific information to the medical facility terminal 170 via the transmission/reception unit 174. After the transmission, the CPU 141 erases the user-specific information and the program read from the medical facility terminal specifying unit 161 that are stored in the RAM 142, and finishes the processing. Note that the user identifying information and the medical facility terminal identifying information associated therewith are used in the processes from step S801 onward that will be explained in FIG. 8 and are therefore consecutively stored in the RAM 142 (step S708).

Further, after step S707, on the medical facility terminal 170 receiving the user-specific information, the CPU 171 of the medical facility terminal 170 stores the received items of information, i.e., the user-specific information and the user identifying information in the RAM 172, and simultaneously acquires the received date/time information (reception date/time) from the clock 178. Then, the received user-specific information, the received user identifying information and the acquired date/time information are stored in the way of being associated with each other by way of a database in the user-specific information storage unit 185 of the auxiliary storage unit 177 (FIG. 2F). After storing the information, the CPU 171 erases the user identifying information and the user-specific information each stored in the RAM 172, and finishes the processing.

The user-specific information stored in the user-specific information storage unit 185 of the medical facility terminal 170 is checked by a medical worker who inputs, when the user undergoes the medical examination in the medical facility or carried to the medical facility, the user identifying information of the handheld device 110 held by the user to the input unit 179. After inputting, the user-specific information associated with this user identifying information in the database stored in the user-specific information storage unit 185 is displayed on the display unit 180 and can be thus checked. Note that upon inputting the user identifying information to the input unit 179, the inputted date/time information (medical examination date/time) is acquired from the clock 178, and the user identifying information and the medical examination date/time are stored in the way of being associated with each other as the database in the user's medical examination history unit 184 of the auxiliary storage unit 177 (FIG. 2G). Incidentally, there may be provided a configuration enabling the medical worker to check the user-specific information by accessing beforehand the user-specific information storage unit 185 before the user undergoes the medical examination in the medical facility or carried to the medical facility.

Incidentally, such an available scheme may also be taken that the CPU 111 of the handheld device 110 transmits the user identifying information in step S701, but instead the CPU 141 of the server device 140 periodically transmits the user identifying information via all of the access points 130 and determines which access point the handheld device 110 associated with the user identifying information receives the information with the strongest reception intensity at. In this case, in step S702, the transmitted user identifying information and the access point information of the access point at which to receive the information with the strongest reception intensity are stored in the RAM 142 of the server device 140.

Note that step S705 may be inserted in between the start (Start) of the processing of the server device 140 and the step S701, and, only when satisfying the predetermined criterion in step S705, the process in step S701 may be advanced. If contrived in this way, when determining that the blood glucose level of the user does not satisfy the predetermined criterion, there is no necessity for the subsequent processes by the server device 140, and it is therefore feasible to reduce the loads applied on the processes of the handheld device 110 and on the processes of the server device 140.

Incidentally, as for step S706 and step S707, other than the medical facility terminal 170 in the communication-enabled region with the access point to which the handheld device 110 belongs, the access point existing in the region neighboring to the belonging access point is also specified, and the user-specific information may be sent to the medical facility terminal in the communication-enabled region with this access point. If thus contrived, if the user employing the handheld device 110 makes a speedy movement by column or by car, and, even when the belonging access point abruptly changes, the proper and prompt treatment can be implemented for the user in the medical facility because of the user-specific information being sent beforehand to the medical facility terminal existing in the communication-enabled region with the access point to which the handheld device 110 reaching the destination of the movement belongs.

Note that if the handheld device 110 is immobilized within the belonging access point or if the user employing the handheld device 110 hardly ever exits the communication-enabled region with the belonging access point, the processes in step S701 through step S704 may be omitted, and only the processes from step S705 onward may be executed. With this contrivance, without user's being aware of the fluctuations of his or her own blood glucose level and when the predetermined criterion is satisfied, the server device 140 automatically transmits the user-specific information to the medical facility terminal 170, and hence, even if the user is carried to the medical facility but unable to conduct the mutual communications with the medical worker, a proper medical care or a proper diagnosis or a proper dosage of medicine is carried out.

It is to be noted that the user using the handheld device 110 swiftly moves across the plurality of access points 130 in a short period of time, it is determined in step S705 that the predetermined criterion is satisfied, and the user-specific information is sent to the medical facility terminal 170, on which occasion if the user has already moved to another access point, step S705 is omitted, and only the processes in remaining steps S701-S704 and S706 to S707 may be executed. With this contrivance, immediately when the handheld device 110 moves to a different access point, the server device 140 can send the user-specific information to the medical facility terminal 170 located in the communication-enabled region with the access point to which the handheld device 110 has moved, and therefore, even if the user is carried to the medical facility but unable to conduct the mutual communications with the medical worker, the proper medical care or the proper diagnosis or the proper dosage of medicine is implemented.

Note that there is a case where the user-specific information does not need sending to all of the medical facility terminals 170 located within the communication-enabled region with a certain access point but is sent to only the medical facility terminal 170 specified by the user. In this case, the auxiliary storage unit 116 of the handheld device 110 is newly provided with a medical facility terminal specifying unit (unillustrated in FIG. 1B), and the handheld device 110 stores the medical facility terminal identifying information associated with the medical facility terminal 170 specified beforehand by the user in the form of the database shown in, e.g., FIG. 2H in the medical facility terminal specifying unit. Then, in step S701, the CPU 111 of the handheld device 110 sends all pieces of the medical facility terminal identifying information stored in the medical facility terminal specifying unit in addition to the user identifying information in the way of being associated with each other to the CPU 141 of the server device 140, and stores the medical facility terminal identifying information together with the user identifying information in the RAM 142 of the server device 140 till the process in step S705.

Next, in step S706, the CPU 141 reads the program stored in the medical facility terminal specifying unit 161 existing in the ROM 147 into the RAM 142, then refers to the database (FIG. 2D) of the medical facility terminal storage unit 151 that is stored in the auxiliary storage unit 148, and specifies the medical facility terminal identifying information associated with the access point information coincident with the access point information stored in the RAM 142 in this database. Then, the CPU 141 determines whether or not this specified medical facility terminal identifying information is coincident with the medical facility terminal identifying information derived from the medical facility terminal specifying unit that is simultaneously stored in the RAM 142, and erases only the discrepant medical facility terminal identifying information. Then, the CPU 141 uses the remaining pieces of medical facility terminal identifying information in the RAM 142 for the process in step S707. This contrivance enables the user-specific information to be sent to only the medical facility terminal specified previously by the user. If it is known beforehand that the user grasps the medical facility where the user is subjected to the optimal treatment or grasps the well-accustomed medical facility and undergoes the medical examination in that medical facility, the process of providing the medical facility terminal specifying unit may also be executed.

Owing to the transmission and the reception of the information among the handheld device 110, the server device 140 and the medical facility terminal 170, the user has no necessity for performing the predetermined operations separately even when the handheld device 110 belongs to the new access point or the blood glucose level satisfies the predetermined criterion, and the user-specific information is previously sent to all of the medical facility terminals 170 within the communication-enabled region with the access point to which the handheld device 110 belongs. Then, owing to the transmission and the reception of the information such as this, even if the user falls into the comatose state due to, e.g., the hypoglycaemia and reaches a state of being disabled from making the mutual communications with the medical facility, the medical facility can grasp the pre-sent user-specific information and can implement the proper medical care or the proper diagnosis or the proper dosage of medicine for the user.

Next, after the user-specific information has been sent to the medical facility terminal 170 in the communication-enabled region with the belonging access point, if the access point to which the handheld device 110 of this user belongs is changed, or if the user has already undergone the medical examination in the medical facility or already been carried to the medical facility in which to install the medical facility terminal 170 to which the user-specific information is sent, the medical facility terminal 170 has no necessity for continuing to store the user-specific information existing in the user-specific information storage unit 185.

Herein, an operation of how the server device 140 erases the user-specific information stored in the user-specific information storage unit 185 in the medical facility terminal 170, will be described with reference to a flowchart in FIG. 8. Note that FIG. 8 shows respective steps in the way of being associated with items of data stored in the RAM 142 of the server device 140 when executing these steps of a processing flow.

The CPU 111 of the handheld device 110 periodically transmits, by way of signals, the pieces of user identifying information stored in the user identifying information storage unit 124. All of the access points capable of receiving these signals transmit the signals to the server device 140 in a way that attaches the access point information allocated to the individual access points and the reception intensities to the signals (step S801).

Next, the CPU 141 of the server device 140 receives the user identifying information coincident with the user identifying information continuously stored in the RAM 142 from step S707 onward in FIG. 7, the access point information and the reception intensity that are transmitted via the access point in step S801, and stores these items of information in the RAM 142. Subsequently, the CPU 141 reads the program stored in the access point information determining unit 155 existing in the ROM 147 into the RAM 142, and executes the following processes. To start with, the CPU 141 compares the reception intensities transmitted from the individual access points with each other in step S801. Then, the CPU 141 selects the access point information received at the strongest reception intensity and stores this access point information in the RAM 142. The CPU 141 erases, other than the thus-stored access point information, the remaining pieces of access point information and the reception intensity information as well. Through this process, the server device 140 acquires the access point information indicating the access point to which the handheld device 110 belongs at the present (step S802).

Next, the CPU 141 refers to the database (FIG. 2B) of the access point information storage unit 152 that is stored in the auxiliary storage unit 148, and searches for the user identifying information coincident with the user identifying information continuing to be stored in the RAM 142 from step S707 onward in FIG. 7, thereby specifying the access point information associated with this user identifying information. Subsequently, the CPU 141 compares this specified information with the access point information stored in the RAM 142. The CPU 141, if different, after the server device 140 has sent the user-specific information to the medical facility terminal 170, determines that there changes the access point to which the handheld device 110 belongs (S803; YES), and advances the processing to step S804. The CPU 141, if coincident, determines that the handheld device 110 remains belonging to the same access point (S803; NO), then erases the program read from the access point information determining unit 155, and thereafter advances the processing to step S805.

Subsequently, the CPU 141 carries out the process of updating the access point information specified in step S803 on the database (FIG. 2B) of the access point information storage unit 152 that is stored in the auxiliary storage unit 148 into the access point information stored in the RAM 142 (step S804). After updating, the CPU 141 erases the program read from the access point information determining unit 155 that is stored in the RAM 142. Note that the user identifying information and the medical facility terminal identifying information associated with this user identifying information, which have been stored in the RAM 142 from step S707 onward in FIG. 7, remain stored therein.

While on the other hand, when determining in step S803 that the handheld device 110 remains belonging to the same access point (S803; NO), the CPU 141 of the server device 140 executes a process of determining whether or not the user employing the handheld device 110 undergoes the medical examination with respect to the medical facility terminal 170 located within the communication-enabled region with this access point. In other words, the CPU 141 executes the process of determining whether or not the user has already undergone the medical examination in the medical facility in which this medical facility terminal 170 is installed or already been carried to this medical facility. A series of these processes will be explained in steps S805, S806, S807 and S808 that will be given as below.

Next, the CPU 141 of the server device 140 reads the program stored in the user's medical examination history checking unit 159 existing in the ROM 147 into the RAM 142, and executes the following processes. To begin with, the CPU 141 of the server device 140 instructs the CPU 171 of the medical facility terminal 170 specified based on the medical facility terminal identifying information continuing to be stored in the RAM 142 from step S707 onward in FIG. 7 to transmit the database (FIG. 2G) of the user's medical examination history unit 184 that is stored in the auxiliary storage unit 177 to the server device 140. Then, the CPU 141 carries out the process of storing the database (FIG. 2G) transmitted from the medical facility terminal 170 in the RAM 142 (step S805).

Subsequently, the CPU 141 refers to this database and searches for the user identifying information coincident with the user identifying information continuing to be stored in the RAM 142 from step S707 onward in FIG. 7, thus determining whether there is the coincident user identifying information or not (step S806). If the coincident user identifying information is not recognized (S806; NO), the CPU 141 erases this database and the access point information that are stored in the RAM 142 and the program read from the user's medical examination history checking unit 159, and returns to the start in FIG. 8. Then, the CPU 141 consecutively waits for the handheld device 110 to transmit the user identifying information in step S801. Whereas if the coincident user identifying information is recognized (S806; YES), the CPU 141 advances the processing to step S807 while keeping this database stored in the RAM 142.

Next, the CPU 141 instructs the CPU 171 of the medical facility terminal 170 specified based on the medical facility terminal identifying information continuing to be stored in the RAM 142 from step S707 onward in FIG. 7 to transmit the database (FIG. 2F) of the user-specific information storage unit 185 existing in the auxiliary storage unit 177 to the server device 140. Then, the CPU 141 executes the process of storing the database sent from the medical facility terminal 170 in the RAM 142 (step S807). Note that the medical facility terminal 170 may take a mode of transmitting not the database (FIG. 2F) itself of the user-specific information storage unit 185 but a database (in which there remain items of data such as the user identifying information and the reception date/time that are associated with each other) configured by removing only the user-specific information from the database (FIG. 2F).

Subsequently, the CPU 141 searches for the user identifying information coincident with the user identifying information continuing to be stored in the RAM 142 from step S707 onward in FIG. 7 on the database stored in the RAM 142 in step S805 and the database (FIG. 2F) stored in the RAM 142 in step S807, and specifies the medical examination date/time and the reception date/time each associated with this user identifying information from the database (FIG. 2G) and the database (FIG. 2F) as well. Then, the CPU 141 compares the medical examination date/time and the reception date/time with each other. The CPU 141, if the medical examination date/time is posterior to the reception date/time (S808; YES), determines that the user undergoes the medical examination in the medical facility where the medical facility terminal 170 is installed. With this determination, the CPU 141 erases the database (FIG. 2G) and the database (FIG. 2F) each stored in the RAM 142 and the program read from the user's medical examination history checking unit 159, and advances the processing to step S809. Whereas if the medical examination date/time is not posterior to the reception date/time (S808; NO), the CPU 141, after erasing the database (FIG. 2G), the database (FIG. 2F) and the access point information each stored in the RAM 142 and the program read from the user's medical examination history checking unit 159, returns to the start in FIG. 8. Then, the CPU 141 consecutively waits for the handheld device 110 to transmit the user identifying information in step S801.

Next, the CPU 141 of the server device 140 reads the program stored in the user-specific information erasing unit 160 existing in the ROM 147 into the RAM 142, and executes the following processes. The CPU 141 instructs the CPUs 171 of all of the medical facility terminals 170 specified based on the medical facility terminal identifying information continuing to be stored in the RAM 147 from step S707 onward in FIG. 7 to erase the user identifying information coincident with the user identifying information continuing to be stored in the RAM 142 from step S707 onward in FIG. 7 and all pieces of information (the reception date/time, the user-specific information) associated with the user identifying information on the database (FIG. 2F) stored in the user-specific information storage unit 185 of the auxiliary storage unit 177. Further, the CPU 141 gives the instruction of erasing the user identifying information coincident with the user identifying information continuing to be stored in the RAM 142 of the server device 140 from step S707 onward in FIG. 7 and the medical examination date/time associated with the user identifying information similarly on the database (FIG. 2G) stored in the user's medical examination history unit 184 of the auxiliary storage unit 177. After the instruction process, the CPU 141 of the server device 140 erases the user identifying information continuing to be stored in the RAM 142, the medical facility terminal identifying information and the access point information each associated therewith and the program read from the user-specific information erasing unit 160, and finishes the processing (step S809).

Incidentally, such an available scheme may also be taken that the CPU 111 of the handheld device 110 transmits the user identifying information in step S801, but instead the CPU 141 of the server device 140 periodically transmits the user identifying information via all of the access points 130 and determines which access point the handheld device 110 associated with the user identifying information receives the information with the strongest reception intensity at. In this case, the CPU 141, in step S802, stores the transmitted user identifying information and the access point at which to receive the information with the strongest reception intensity in the RAM 142 of the server device 140.

With the transmission and the reception of the information among the handheld device 110, the server device 140 and the medical facility terminal 170, the user-specific information having no necessity of continuing to be stored on the medical facility terminal 170 does not separately require the predetermined operations on the side of the medical facility and can be automatically erased by the instruction given from the server device 140. Then, owing to the transmission and the reception of the information such as this, the user-specific information is stored only on the medical facility terminal 170 belonging to the communication-enabled region with the access point within a period for which the user remains belonging to this access point and is therefore, it follows, dealt with in the minimum range outside the handheld device 110. As a result, the user-specific information can be prevented from leaking outside the medical facility.

The present embodiment does not restrict a technique of realizing the respective processing units such as the access point information determining unit 155, which are included by the handheld device 110, the server device 140 and the medical facility terminal 170. The respective processing units may be configured as hardware components or software components or combinations thereof by a technique realizable to ordinary engineers in the field of the present technology.

The hardware component is a hardware circuit which can be exemplified by an FPGA (Field Programmable Gate Array), an ASIC (Application Specific Integrated Circuit), a gate array, a combination of logic gates, a signal processing circuit, an analog circuit, etc. The software component is defined as a component (fragment) which realizes softwarewise the process described above but is not a concept which limits a language, a development environment, etc for realizing the software. The software component is exemplified by, e.g., a task, a thread, a driver, firmware, a database, a table, a function, a procedure, a subroutine, a predetermined segment of a program code, a data structure, an array, a variable and a parameter. These software components are realized on a single memory or a plurality of memories in the computer or realized by a single processor or a plurality of processors (e.g., a CPU (Central Processing Unit), DSP (Digital Signal Processor), etc) which run the data on the single or plural memories.

### INDUSTRIAL APPLICABILITY

According to the present invention, even if the user falls into the comatose state due to, e.g., the hypoglycaemia and reaches the state of being disabled from making the mutual communications with the medical facility, the medical facility in which to install the medical facility terminal can grasp the pre-sent user-specific information and can implement the proper medical care or the proper diagnosis or the proper dosage of medicine for the user. On the other hand, if the sent user-specific information becomes unnecessary, the predetermined operations are not performed separately on the side of the medical facility terminal, but the automatically erasing process is executed on the side of the server device, and hence the user-specific information can be safely handled without any necessity for taking account of the working load for separately managing the user-specific information. As a result, it is feasible to save the time-consuming operations of managing the user-specific information, which are burdened onto both of the user and the medical facility.

### DESCRIPTION OF THE REFERENCE NUMERALS AND SYMBOLS

110 handheld device
111 CPU (of handheld device)
112 measuring unit
113 analog signal processing unit
114 analog-to-digital (A/D) conversion unit
115 transmission/reception unit (of handheld device)
116 auxiliary storage unit (of handheld device)
117 ROM (of handheld device)
118 RAM (of handheld device)
119 EEPROM (of handheld device)
120 clock (of handheld device)
121 gate array (of handheld device)
122 display unit (of handheld device)
123 input unit (of handheld device)
124 user identifying information storage unit
125 user-specific information storage unit (of handheld device)
126 measurement data storage unit
127 calibration curve data storage unit
128 modem (of handheld device)
129 NCU (of handheld device)
130 access point
1311-133 access point installed in each region
134 communication network
140 server device
141 CPU 141 (of server device)
142 RAM (of server device)
143 NCU (of server device)
144 modem (of server device)
145 transmission/reception unit (of server device)
146 EEPROM (of server device)
147 ROM (of server device)
148 auxiliary storage unit (of server device)
149 clock (of server device)
150 user-specific information storage unit (of server device)
151 medical facility terminal storage unit
152 access point information storage unit
153 profile generation storage unit
154 user-specific information updating unit
155 access point information determining unit
156 biometric information profile generation unit
157 fluctuation pattern specifying unit
158 biometric information prediction determining unit
159 user's medical examination history checking unit
160 user-specific information erasing unit
161 medical facility terminal specifying unit

1. A user-specific information provision system comprising:
a handheld device transmitting, to a server device, user-specific information held specifically by a user and user's biometric information acquired by measuring biometric information of the user;
the server device receiving the user-specific information and the user's biometric information; and
a medical facility terminal receiving information transmitted from the server device,
the server device including an access point information determining unit acquiring access point information representing an access point to which the handheld device belongs at present and determining whether the access point is changed or not,
at least one of the handheld device and the server device, further including a biometric information prediction determining unit determining whether or not the user's biometric information satisfies a predetermined criterion,
wherein the server device transmits the user-specific information to the medical facility terminal when determining that the access point is changed and/or when determining that the predetermined criterion is satisfied.

2. The user-specific information provision system according to claim 1, wherein the server further includes an access point information storage unit to store access point information of the handheld device, and
the access point information determining unit determines that the access point to which the handheld device belongs is changed when the acquired access point information is different from the access point information stored in the access point information storage unit.

3. The user-specific information provision system according to claim 1, wherein at least one of the handheld device and the server device further includes:
a biometric information profile generation unit generating a user-specific biometric information profile, based on past user's biometric information of the user, with which a fluctuation pattern of the past user's biometric information and a fluctuation information value of prospective user's biometric information when the fluctuation pattern occurs are associated; and
a fluctuation pattern specifying unit specifying the fluctuation pattern of the past user's biometric information, which is coincident with a fluctuation pattern of recent user's biometric information of the user, among the biometric information profile generated by the biometric information profile generation unit, and
the biometric information prediction determining unit further calculates a predictive value of the prospective user's biometric information by adding the fluctuation value of the prospective user's biometric information, which is associated with the fluctuation pattern of the past user's biometric information specified by the fluctuation pattern specifying unit, to present user's biometric information, and determines whether the user's biometric information satisfies the predetermined criterion or not by using the predictive value of the prospective user's biometric information.

4. The user-specific information provision system according to claim 1, wherein the medical facility terminal further includes a user-specific information storage unit to store the transmitted user-specific information, and
the server device erases the user-specific information stored in the user-specific information storage unit of the medical facility terminal when the access point information determining unit determines that the access point to which the handheld device belongs is changed after the server device has transmitted the user-specific information to the medical facility terminal.

5. (canceled)

6. (canceled)

7. A user-specific information provision method executed by a handheld device capable of transmitting, to a server device, user-specific information held specifically by a user and user's biometric information acquired by measuring biometric information of the user, the server device receiving the user-specific information and the user's biometric information, and a medical facility terminal receiving information transmitted from the server device, the method comprising:
a step of the server device acquiring access point information representing an access point to which the handheld device belongs at present and determining whether the access point is changed or not;
a biometric information prediction determining step of at least one of the handheld device and the server device determining whether the user's biometric information satisfies a predetermined criterion or not;
an access point information determining step of the server device determining whether the access point is changed or not; and
a step of the server device transmitting the user-specific information to the medical facility terminal when determining that the predetermined criterion is satisfied and/or when determining that the access point is changed.

8. The user-specific information provision method according to claim 7, wherein the server further includes an access point information storage unit to store access point information of the handheld device, and
the access point information determining step determines that the access point to which the handheld device belongs is changed when the acquired access point information is different from the access point information stored in the access point information storage unit.

9. The user-specific information provision method according to claim 7, wherein the biometric information prediction determining step further includes:
a biometric information profile generation step of generating a user-specific biometric information profile, based on past user's biometric information of the user, with which a fluctuation pattern of the past user's biometric information and a fluctuation value of prospective user's biometric information when the fluctuation pattern occurs are associated;
a fluctuation pattern specifying step of specifying the fluctuation pattern of the past user's biometric information, which is coincident with a fluctuation pattern of recent user's biometric information of the user, among the biometric information profile generated in the biometric information profile generation step:
a step of calculating a predictive value of the prospective user's biometric information by adding the fluctuation value of the prospective user's biometric information when the fluctuation pattern of the past user's biometric information occurs, which is specified in the fluctuation pattern specifying step, to present user's biometric information; and
a step of determining by using the predictive value of the prospective user's biometric information whether the user's biometric information satisfies the predetermined criterion or not.

10. The user-specific information provision method according to claim 7, wherein the medical facility terminal further includes a user-specific information storage unit to store the transmitted user-specific information, and
the method comprises:
an access point information determining step of the server device determine that the access point to which the handheld device belongs is changed after the step of transmitting the user-specific information to the medical facility terminal; and
a user-specific information erasing step of the server device erasing the user-specific information stored in the user-specific information storage unit of the medical facility terminal when determining that the access point is changed.

11. A server device receiving user-specific information transmitted from a handheld device and held specifically by a user and user's biometric information acquired by measuring biometric information of the user, comprising:
an access point information determining unit acquiring access point information representing an access point to which the handheld device belongs at present and determining whether the access point is changed or not;
a biometric information prediction determining unit determining whether or not the user's biometric information satisfies a predetermined criterion; and
a medical facility terminal specifying unit transmitting the user-specific information to a medical facility terminal, when determining that the access point is changed and/or when determining that the predetermined criterion is satisfied.

12. The server device according to claim 11, further comprising an access point information storage unit to store access point information of the handheld device,
wherein the access point information determining unit determines that the access point to which the handheld device belongs is changed when the acquired access point information is different from the access point information stored in the access point information storage unit.

13. The server device according to claim 11, further comprising:
a biometric information profile generation unit generating a user-specific biometric information profile, based on past user's biometric information of the user, with which a fluctuation pattern of the past user's biometric information and a fluctuation value of prospective user's biometric information when the fluctuation pattern occurs are associated; and
a fluctuation pattern specifying unit specifying the fluctuation pattern of the past user's biometric information, which is coincident with a fluctuation pattern of user's recent biometric information of the user, from within the biometric information profile generated by the biometric information profile generation unit,
wherein the biometric information prediction determining unit further calculates a predictive value of the prospective user's biometric information by adding the fluctuation value of the prospective user's biometric information that is associated with the fluctuation pattern of the past user's biometric information specified by the fluctuation pattern specifying unit, to present user's biometric information, and determines by using the predictive value of the prospective user's biometric information whether the user's biometric information satisfies the predetermined criterion or not.

14. The server device according to claim 11, further comprising a user-specific information erasing unit erasing the user-specific information stored on the medical facility terminal, when the access point information determining unit determines that the access point to which the handheld device belongs is changed after transmitting the user-specific information to the medical facility terminal.

15. (canceled)

16. (canceled)

17. A handheld device capable of transmitting, to a server device, user-specific information held specifically by a user and user's biometric information acquired by measuring biometric information of the user, the handheld device comprising:
a biometric information prediction determining unit determining whether the biometric information satisfies a predetermined criterion or not; and
a determination result transmitting unit transmitting a result of the determination to the server device when determining that the predetermined criterion is satisfied.

18. The handheld device according to claim 17, wherein the determination result transmitting unit further transmits the user-specific information to the server device when determining that the predetermined criterion is satisfied.

19. The handheld device according to claim 17, further comprising:
a biometric information profile generation unit generating a user-specific biometric information profile, based on past user's biometric information of the user, with which a fluctuation pattern of the past user's biometric information and a fluctuation value of prospective user's biometric information when the fluctuation pattern occurs are associated; and
a fluctuation pattern specifying unit specifying the fluctuation pattern of the past user's biometric information, which is coincident with a fluctuation pattern of recent user's biometric information of the user, among the biometric information profile generated by the biometric information profile generation unit,
wherein the biometric information prediction determining unit further calculates a predictive value of the prospective user's biometric information by adding the fluctuation value of the prospective user's biometric information that is associated with the fluctuation pattern of the past user's biometric information specified by the fluctuation pattern specifying unit, to present user's biometric information, and determines by using the predictive value of the prospective user's biometric information whether the user's biometric information satisfies the predetermined criterion or not.

20.-27. (canceled)
